(19) United States
(12) Patent Application Publication
(10) Pub. No.: US 2024/0026509 A1
(43) Pub. Date: Jan. 25, 2024

(54) HIGH MOLYBDENUM DUPLEX STAINLESS STEEL

(71) Applicant: Carpenter Technology Corporation, Philadelphia, PA (US)

(72) Inventors: Austin Dicus, New Holland, PA (US); Stephane Alexis Jacques Forsik, Reading, PA (US)

(21) Appl. No.: 18/355,913

(22) Filed: Jul. 20, 2023

Related U.S. Application Data
(60) Provisional application No. 63/391,512, filed on Jul. 22, 2022.

(51) Int. Cl. C22C 38/58; C22C 38/52; C22C 38/44; C22C 38/42; C22C 38/00; B33Y 70/00; C22C 33/04; B22F 1/05; B22F 1/065; B22F 9/08; C21D 8/00; C21D 6/00; C21D 1/18; C21D 1/60

(52) U.S. Cl. CPC C22C 38/58; C22C 38/52; C22C 38/44; C22C 38/42; C22C 38/001; B33Y 70/00; C22C 33/04; B22F 1/05; B22F 1/065; B22F 9/082; C21D 8/005; C21D 6/004; C21D 6/005; C21D 6/007; C21D 1/18; C21D 1/60; B22F 2301/35; B22F 2009/086; B22F 2998/10; B22F 2999/00; B22F 2201/50; B22F 2201/10; B22F 2201/20; B22F 2009/0824; C21D 2211/005; C21D 2211/001

(57) ABSTRACT

Disclosed herein are duplex stainless steel alloys comprising 40 wt %-60 wt % ferrite and 60 wt %-40 wt % austenite and methods of formation thereof, the alloys including or consisting essentially of
from 10 wt % to 20 wt % chromium (Cr);
from 6 wt % to 13 wt % molybdenum (Mo);
from 0.5 wt % to 6.5 wt % nickel (Ni);
from 2.25 wt % to 12 wt % manganese (Mn);
from 0.05 wt % to 5 wt % copper (Cu);
from 0.05 wt % to 0.4 wt % nitrogen (N);
from 0.05 wt % to 0.35 wt % carbon (C);
from 0.01 wt % to 3.5 wt % cobalt (Co);
less than 2 wt % silicon (Si);
less than 2 wt % tungsten (W); and
iron (Fe) balance.
   The duplex stainless steel alloy may include cast or wrought steel, or it may be in powder form.

### CROSS REFERENCE TO RELATED APPLICATION

This application claims priority to U.S. Provisional Application No. 63/391,512, filed on Jul. 22, 2022, which is incorporated by reference herein in its entirety and for all purposes.

### BACKGROUND

Duplex stainless steels (DSS) are a subfamily in the stainless steel alloy family. These materials are commonly used in the industrial and energy markets in view of their combination of corrosion resistance, strength, and impact toughness. Applications include oil/gas equipment and pipelines; subsea and marine components and ship parts, and industrial—heat exchangers, piping, and chemical processing.

The microstructure of DSS is unique, exhibiting both austenite and ferrite phases, roughly 60-40% and 40-60% respectively.

The four main alloying elements in this steel family are chromium (Cr), molybdenum (Mo), nickel (Ni), and nitrogen (N). Cr and Mo act as ferrite stabilizers, and Ni and N act as austenite stabilizers. Referring to FIG. 1, a microstructure of 2507 DSS includes both ferrite stabilizers (black/gray) and austenite stabilizers (white).

A general trend for achieving higher mechanical properties and corrosion performance for duplex steels has been to increase the Cr and Ni content, thus balancing phases. Some exemplary DSS compositions are
Lean Duplex—2101, 2102, 2202, 2304: 21-23 wt % Cr, 1-4 wt % Ni, <1 wt % Mo
Duplex—2205, 2003, 2404: 20-24 wt % Cr, 3-5 wt % Ni, 1-3.5 wt % Mo
Super Duplex—2507, 255, Z100: 25 wt % Cr, 5.5-7 wt % Ni, 3.5-4.5 wt % Mo
Hyper Duplex—2707: >27 wt % Cr, 6.5 wt % Ni, 4.8 wt % Mo
Hyper Duplex—3207: >32 wt % Cr, 7 wt % Ni, 3.5 wt % Mo

### SUMMARY

A potential disadvantage of having higher Cr content and/or higher Ni content is the formation of deleterious phases (sigma and chi) during processing, as increasing Cr or Ni content increases the solvus temperature of deleterious phases. See, for example, FIG. 2 that illustrates how the sigma solvus temperature of DSS 2507 increases with Ni content. If the deleterious phases sigma and/or chi are abundantly present in the alloy during processing, e.g., during hot working, the risk of formation of processing defects (cracks, tears, porosity, etc.) increases. Moreover, a higher Ni content may also result in higher costs. If phase balancing is not correctly done, then the temperature difference between the temperature of deleterious phase formation and the duplex temperature (50/50 austenite to ferrite) remains small, leading to processing challenges and negatively impacting mechanical and corrosion performance. Ideally, the difference between the solvus temperature and the duplex temperature (“delta temperature”) is as large as possible to improve alloy yield and processing.

In an aspect, embodiments of the invention relate to a duplex stainless steel alloy. The stainless steel alloy includes, or consists essentially of, from 10 wt % to 20 wt % chromium (Cr); from 6 wt % to 13 wt % molybdenum (Mo); from 0.5 wt % to 6.5 wt % nickel (Ni); from 2.25 wt % to 12 wt % manganese (Mn); from 0.05 wt % to 5 wt % copper (Cu); from 0.05 wt % to 0.4 wt % nitrogen (N); from 0.05 wt % to 0.35 wt % carbon (C); from 0.01 wt % to 3.5 wt % cobalt (Co); less than 2 wt % silicon (Si); less than 2 wt % tungsten (W); and iron (Fe) balance.

The stainless steel alloy includes 40 wt %-60 wt % ferrite and 60 wt %-40 wt % austenite, and has a nickel equivalent and a chromium equivalent. The nickel equivalent and the chromium equivalent are defined as one of (i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), with Ni_{eq} and Cr_{eq} having values of 7<Ni_{eq}<20 and 21<Cr_{eq}<38, respectively; or (ii) nickel equivalent (Ni_{eq})=wt % Ni+(30×wt % C)+(0.5×wt % Mn)+(30×wt % N), and chromium equivalent (Cr_{eq})=wt % Cr+wt % Mo+(1.5×wt % Si)+(0.5×wt % Nb), with Ni_{eq} and Cr_{eq} having values of 10<Ni_{eq}<18 and 21<Cr_{eq}<27, respectively.

One or more features may be included. The stainless steel alloy may include from 12 wt % to 17 wt % chromium (Cr); from 7.25 wt % to 11 wt % molybdenum (Mo); from 0.75 wt % to 5 wt % nickel (Ni); from 2.5 wt % to 8 wt % manganese (Mn); from 1.75 wt % to 3.5 wt % copper (Cu); from 0.1 wt % to 0.3 wt % nitrogen (N); from 0.075 wt % to 0.2 wt % carbon (C); from 0.01 wt % to 3 wt % cobalt (Co); less than 1.5 wt % silicon (Si); less than 1.5 wt % tungsten (W); and iron (Fe) balance.

The stainless steel alloy may include cast steel and/or wrought steel. The stainless steel alloy may have a yield strength of at least 70 ksi, an ultimate tensile strength of at least 115 ksi, an elongation>30%, a reduction of area>50%, and/or a pitting resistance equivalent number value of at least 30.

In another aspect, embodiments of the invention relate to a duplex stainless steel alloy powder for additive manufacturing. The powder includes or consists essentially of from 10 wt % to 20 wt % chromium (Cr); from 6 wt % to 13 wt % molybdenum (Mo); from 0.5 wt % to 6.5 wt % nickel (Ni); from 2.25 wt % to 12 wt % manganese (Mn); from 0.05 wt % to 5 wt % copper (Cu); from 0.05 wt % to 0.4 wt % nitrogen (N); from 0.05 wt % to 0.35 wt % carbon (C); from 0.01 wt % to 3.5 wt % cobalt (Co); less than 2 wt % silicon (Si); less than 2 wt % tungsten (W); and iron (Fe) balance.

The stainless steel alloy includes 40 wt %-60 wt % ferrite and 60 wt %-40 wt % austenite, and has a nickel equivalent and a chromium equivalent. The nickel equivalent and the chromium equivalent are defined as one of (i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), with Ni_{eq} and Cr_{eq} having values of 7<Ni_{eq}<20 and 21<Cr_{eq}<38, respectively; or (ii) nickel equivalent (Ni_{eq})=wt % Ni+(30×wt % C)+(0.5×wt % Mn)+(30×wt % N), and chromium equivalent (Cr_{eq})=wt % Cr+wt % Mo+(1.5×wt % Si)+(0.5×wt % Nb), with Ni_{eq} and Cr_{eq} having values of 10<Ni_{eq}<18 and 21<Cr_{eq}<27, respectively. The powder includes a plurality of spherical particulates having a mean particle size selected from a range of 15-53 microns or 45-103 microns.

The powder may include, or consist essentially of, from 12 wt % to 17 wt % chromium (Cr); from 7.25 wt % to 11 wt % molybdenum (Mo); from 0.75 wt % to 5 wt % nickel (Ni); from 2.5 wt % to 8 wt % manganese (Mn); from 1.75 wt % to 3.5 wt % copper (Cu); from 0.1 wt % to 0.3 wt % nitrogen (N); from 0.075 wt % to 0.2 wt % carbon (C); from 0.01 wt % to 3 wt % cobalt (Co); less than 1.5 wt % silicon (Si); less than 1.5 wt % tungsten (W); and iron (Fe) balance.

In still another aspect, embodiments of the invention relate to a method for forming a duplex stainless steel alloy, the method includes the step of melting a mixture of elements to form a molten metal alloy including or consisting essentially of from 10 wt % to 20 wt % chromium (Cr); from 6 wt % to 13 wt % molybdenum (Mo); from 0.5 wt % to 6.5 wt % nickel (Ni); from 2.25 wt % to 12 wt % manganese (Mn); from 0.05 wt % to 5 wt % copper (Cu); from 0.05 wt % to 0.4 wt % nitrogen (N); from 0.05 wt % to 0.35 wt % carbon (C); from 0.01 wt % to 3.5 wt % cobalt (Co); less than 2 wt % silicon (Si); less than 2 wt % tungsten (W); and iron (Fe) balance. The stainless steel alloy includes 40 wt %-60 wt % ferrite and 60 wt %-40 wt % austenite, and has a nickel equivalent and a chromium equivalent, defined as one of (i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), Ni_{eq} and Cr_{eq} having values of 7<Ni_{eq}<20 and 21<Cr_{eq}<38, respectively; or (ii) nickel equivalent (Ni_{eq})=wt % Ni+(30×wt % C)+(0.5×wt % Mn)+(30×wt % N), and chromium equivalent (Cr_{eq})=wt % Cr+wt % Mo+(1.5×wt % Si)+(0.5×wt % Nb), with Ni_{eq} and Cr_{eq} having values of 10<Ni_{eq}<18 and 21<Cr_{eq}<27, respectively. The molten metal alloy is quenched to solidify the metal alloy.

The method may include forging the solidified metal alloy. The forged metal alloy may be heat treated.

In another aspect, embodiments of the invention relate to method for forming a duplex stainless steel alloy powder having a composition including or consisting essentially of from 10 wt % to 20 wt % chromium (Cr); from 6 wt % to 13 wt % molybdenum (Mo); from 0.5 wt % to 6.5 wt % nickel (Ni); from 2.25 wt % to 12 wt % manganese (Mn); from 0.05 wt % to 5 wt % copper (Cu); from 0.05 wt % to 0.4 wt % nitrogen (N); from 0.05 wt % to 0.35 wt % carbon (C); from 0.01 wt % to 3.5 wt % cobalt (Co); less than 2 wt % silicon (Si); less than 2 wt % tungsten (W); and iron (Fe) balance. The stainless steel alloy includes 40 wt %-60 wt % ferrite and 60 wt %-40 wt % austenite, and has a nickel equivalent and a chromium equivalent defined as one of (i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), Ni_{eq} and Cr_{eq} having values of 7<Ni_{eq}<20 and 21<Cr_{eq}<38, respectively; or (ii) nickel equivalent (Ni_{eq})=wt % Ni+(30×wt % C)+(0.5×wt % Mn)+(30×wt % N), and chromium equivalent (Cr_{eq})=wt % Cr+wt % Mo+(1.5×wt % Si)+(0.5×wt % Nb), Ni_{eq} and Cr_{eq} having values of 10<Ni_{eq}<18 and 21<Cr_{eq}<27, respectively. The powder includes a plurality of spherical particulates having a mean particle size selected from a range of 15-53 microns or 45-103 microns. The method includes melting charge material including the composition to form a molten metal bath. A molten metal stream is generated from the molten metal bath. The molten metal stream is atomized to form a plurality of metal droplets. The metal droplets are cooled such that the metal droplets solidify to form the powder.

The charge material may be melted in an atmosphere including air, an inert gas, and/or vacuum. The molten metal stream may be atomized in a high-pressure gas including argon, nitrogen, and/or helium.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a micrograph illustrating a duplex stainless steel of the prior art;

FIG. 2 is a graph illustrating an increase in the sigma solvus temperature of DSS with Ni content;

FIG. 3A is a Schaeffler diagram illustrating the phases that form in stainless steel, as a function of different compositions;

FIG. 3B is a Long and Delong diagram illustrating the phases that form in stainless steel, as a function of different compositions;

FIG. 4 is a micrograph illustrating the microstructure of a duplex stainless steel in accordance with an embodiment of the invention; and

FIGS. 5A and 5B are images illustrating nitrogen outgassing and blow holes when the carbon level in a stainless steel composition is too low (e.g., below 0.05%).

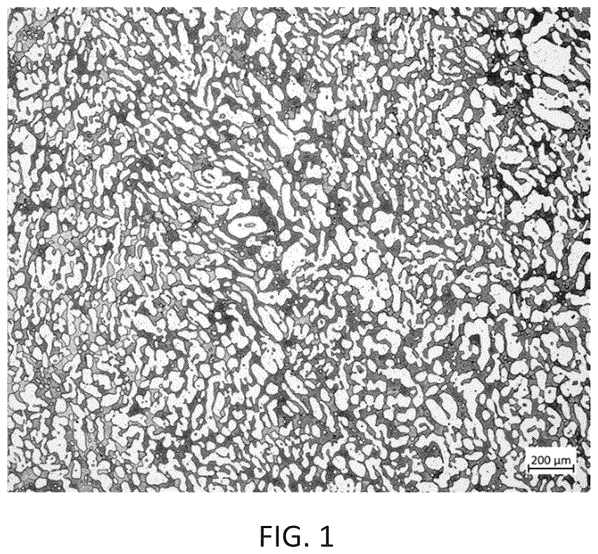

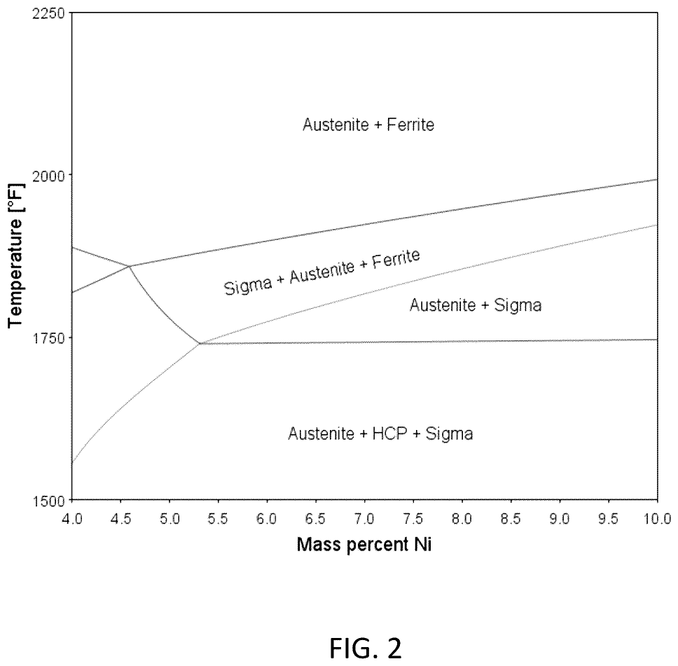

### DETAILED DESCRIPTION

In many conventional duplex stainless steels, the inclusion of high chromium content is needed to aid in corrosion resistance. For DSS to achieve higher mechanical and corrosion properties one may continue to increase the alloying elements (e.g., Cr>30%). However, higher levels of Cr increase the cost, as well as the formation of deleterious phases (sigma and chi) during processing. Moreover, by continuing to increase Cr and Ni in DSS compositions, gains in corrosion resistance are typically offset by an increase in the sigma and/or chi solvus temperature, with the hot working window shrinking accordingly.

Alloy compositions in accordance with embodiments of the invention include a rebalancing of the levels of Cr, Mo, Ni, and N to lower the solvus temperature of the deleterious sigma and chi phases, which aids processability as well as mechanical and corrosion properties. In particular, the wt % of Cr is lowered to more appropriate levels while still maintaining corrosion resistance. In parallel, the wt % of Mo is increased to be higher than that of conventional DSS, as Mo is better for solid solutioning strengthen and corrosion resistance than Cr. The amounts of Cr and Mo are selected to still enable the formation of a duplex structure (40-60% ferrite, and 60-40% austenite). Phase balance is performed with Ni, N, Mn, and Cu. The compositions include less than 2 wt % Si and W, and less than 3.5 wt % Co.

Exemplary composition range, in accordance with embodiments of the invention, are provided in Tables 1 and 2.

TABLE 1
Exemplary alloy composition

| Element | Minimum (wt %) | Maximum (wt %) |
|---|---|---|
| Cr | 10 | 20 |
| Mo | 6 | 13 |
| Ni | 0.5 | 6.5 |
| Mn | 2.25 | 12 |
| Cu | 0.05 | 5 |
| N | 0.05 | 0.4 |
| C | 0.05 | 0.35 |
| Co | 0.01 | 3.5 |
| Si | 0 | less than 2 |
| W | 0 | less than 2 |
| Fe | balance | balance |

TABLE 2
Exemplary alloy composition

| Element | Minimum (wt %) | Maximum (wt %) |
|---|---|---|
| Cr | 12 | 17 |
| Mo | 7.25 | 11 |
| Ni | 0.75 | 5 |
| Mn | 2.5 | 8 |
| Cu | 1.75 | 3.5 |
| N | 0.1 | 0.3 |
| C | 0.075 | 0.2 |
| Co | 0.01 | 3 |
| Si | 0 | less than 1.5 |
| W | 0 | less than 1.5 |
| Fe | balance | balance |

The relationships between certain elements of the compositions described herein may be determined by calculating nickel and chromium equivalents and referring to phase diagrams. In particular, nickel and chromium equivalents for given compositions may be calculated as follows:
Nickel equivalent (Ni_{eq})=wt % Ni+(0.5×wt % Mn)+(30×wt % C); and
Chromium equivalent (Cr_{eq})=wt % Cr+wt % Mo+(1.5×wt % Si)+(0.5×wt % Nb).

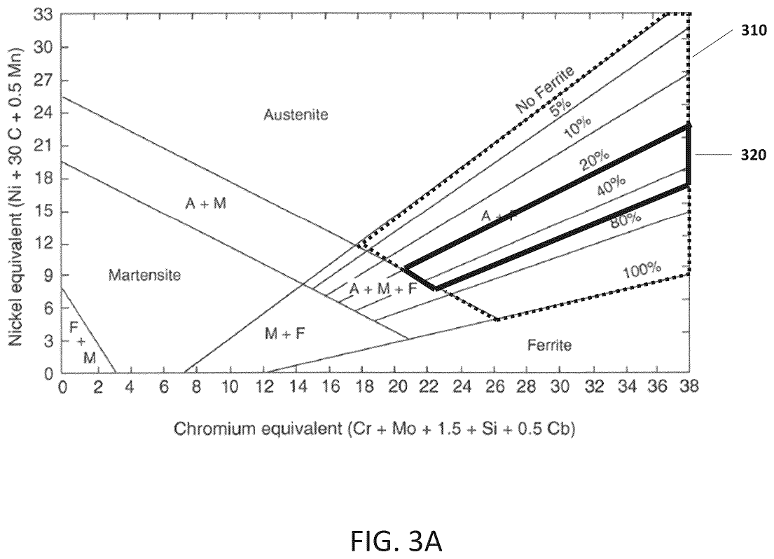

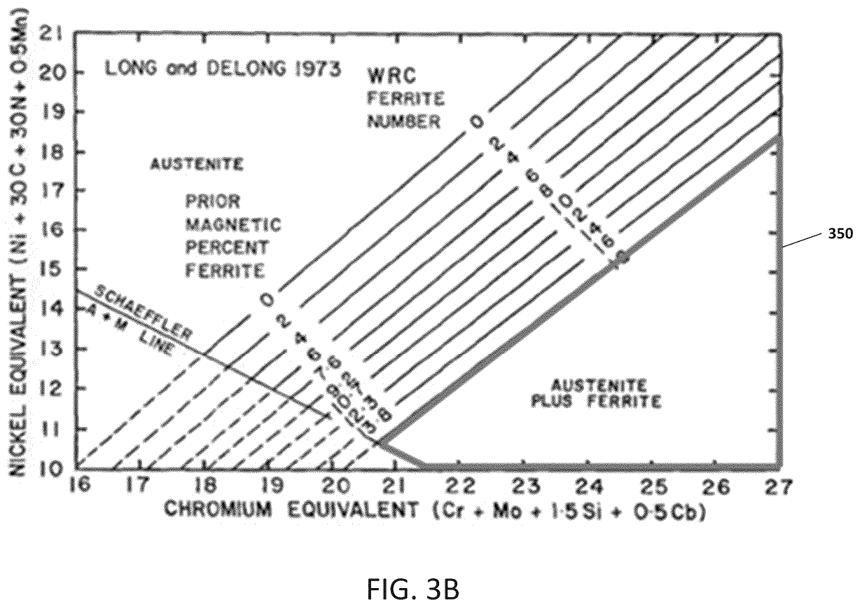

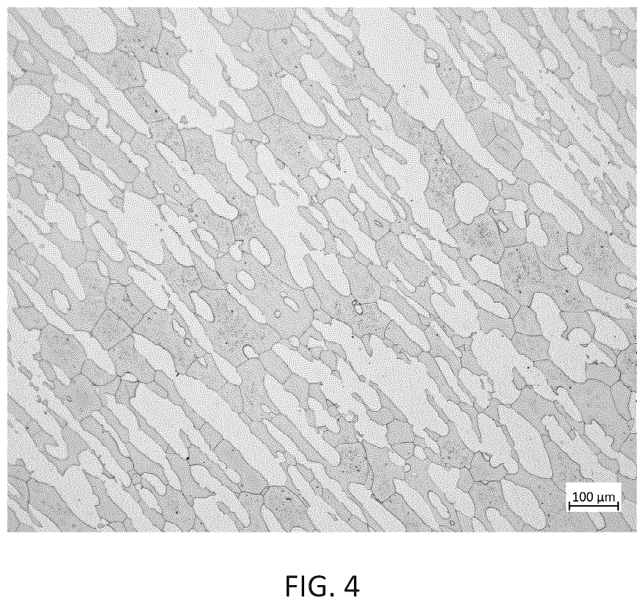

Referring to the Schaeffler diagram of FIG. 3A (reproduced from Lippold, J. C., & Kotecki, D. J. (2005a). Alloying Elements and Constitution Diagrams. In Welding Metallurgy and Weldability of Stainless Steels (pp. 31-34), John Wiley), stable phases of both austenite and ferrite may form when 18<Cr_{eq}<38 and 5<Ni_{eq}<33 (phase area 310 in FIG. 3A). In other embodiments, stable phases of both austenite and ferrite may form when 18<Cr_{eq}<35 and 5<Ni_{eq}<33, as well as when 18<Cr_{eq}<30 and 5<Ni_{eq}<33.

In a duplex stainless steel, the amounts of austenite and ferrite are roughly equal, i.e. 40-60% austenite and 60-40% ferrite. Accordingly, a duplex stainless steel forms when the nickel and chromium equivalents are within the values defined by phase area 320. Here, 21<Cr_{eq}<38 and 7<Ni_{eq}<20 (phase area 320 in FIG. 3A).

Alternatively, the relationships between certain elements of the compositions described herein may be determined by the equations below and the Long and DeLong diagram of FIG. 3B:
Nickel equivalent (Ni_{eq})=wt % Ni+(0.5×wt % Mn)+(30×wt % C)+(30×wt % N)
Chromium equivalent (Cr_{eq})=wt % Cr+wt % Mo+(1.5×wt % Si)+(0.5×wt % Nb)

Referring to the Long and DeLong diagram of FIG. 3B (reproduced from Lippold, J. C., & Kotecki, D. J. (2005a). Alloying Elements and Constitution Diagrams. In Welding Metallurgy and Weldability of Stainless Steels (pp. 31-34), John Wiley), stable phases of both austenite and ferrite may form when 21<Cr_{eq}<27 and 10<Ni_{eq}<1⁸ (phase area 350 in FIG. 3B). The large difference in Ni- and Cr-equivalent ranges based on the Schaeffler and Long/DeLong diagrams is due to the latter including nitrogen in the experiments and tables, while the former does not.

Duplex stainless steel alloys in accordance with embodiments of the invention do not contain niobium; accordingly, wt % Nb in the Cr_{eq} equations is equal to zero for compositions described herein.

Typically, an alloy with too much ferrite is less corrosion resistant with lower toughness, but with higher strength. An alloy with too much austenite is more corrosion resistant with higher toughness, but with lower strength.

The function of the various elements in embodiments of the invention are described below, along with the criteria for selecting the levels of these elements.

Cr: Chromium (Cr) is a key element for both ferrite stabilization, and corrosion resistance. The necessary level is reduced in comparison to conventional duplex alloys down to 10-20 wt %. This range of Cr still provides the necessary corrosion resistance for a stainless steel, but decreases the solvus temperature of detrimental phases, such as sigma and chi. Preferably, Cr levels are in the range of 12-17 wt %.

Mo: Molybdenum (Mo) is another ferrite stabilizer, but it also greatly increases the corrosion resistance of this alloy. This element is essential in the range of 6-13 wt %. Just like Cr, if the levels of Mo are too high the formation of detrimental phases, sigma and chi, impacts processability. If the Mo levels are below 6 wt %, with the combination of lower Cr levels, that material does not form the needed amount of the ferrite phase necessary for processing and corrosion resistance. For these reasons, the preferred Mo range is 7.25-11%.

The lower limit of molybdenum is needed for two main reasons—corrosion resistance, and solid solution strengthening. Due to the inherent lower level of Cr in the alloy a minimum of 6 wt % Mo, e.g., a minimum of 7.25 wt % Mo, is required to meet the corrosion resistance level found in most duplex stainless steels. In terms of mechanical properties and strength, Mo is a stronger solid solution strengthener than Cr in stainless steels, thus a level of at least 6 wt %, e.g., at least 7.25 wt %, is needed to maintain a high level of strength. A combination of corrosion resistance and high strength is possible if the levels of Mo are sufficiently high.

The primary reason for an upper limit of molybdenum is to avoid deleterious phase formation. In particular, above the level of 11 wt % Mo, e.g., above 13 wt % Mo, deleterious phases (sigma, chi) form at higher temperature. Higher deleterious phase solvus temperatures can lead to more difficulties processing alloys. This higher solvus temperature would cause a higher volume fraction of this brittle intermetallic phase, likely leading to cracks and tearing during hot working. Besides processing, formation of these deleterious phases during heat treatment or cooling negatively impacts mechanical properties and corrosion resistance. A Mo level below 11 wt % offers a compromise between processability (hot working and heat treatment) and alloy performance. If the Mo level is pushed above 13 wt %, the resulting alloy may not be processable via conventional methods. Furthermore, in order to maintain a duplex structure, Mo levels>13 wt % would require inclusion of <10 wt % Cr; thus, the resulting alloy would no longer be a stainless steel, and would be extremely prone to corrosion.

Ni: Nickel (Ni) is used primarily to stability austenite and balance the austenite/ferrite phase fraction. Therefore, a range of 0.5-6.5 wt % is suitable for this major alloy element. Excessive Ni however, can increase the solvus temp of detrimental phases, which can lead to process challenges. Thus, a preferred Ni range is 0.75-5 wt %.

Mn: Manganese (Mn), like Ni, is an austenite stabilizer and is used to promote the formation of austenite. Mn can also increase the solubility of nitrogen, which is another key alloying element. If the Ni level is on the low end of the Ni ranges indicated above, more Mn may be needed to balance the austenite phase fraction, and vice versa—therefore a preferred Mn range is 2.25-12 wt %. However, excessive Mn can decrease the overall corrosion resistance of the alloy but can be utilized as a cost-effective austenite stabilizer if Ni prices become volatile. For these reasons, a preferred Mn range is 2.5-8 wt %.

The lower limit of manganese is needed for three reasons—deleterious phase suppression, phase balance, and nitrogen solubility. Since higher Ni can lead to an increase in deleterious phase solvus temperature, Mn can be used to partially replace Ni and still maintain phase balance. Below a level of 2% Mn, either the concentration of Ni becomes too high and deleterious phases form, or the concentration of Ni is kept low and an imbalance of phases occurs, and the material is no longer duplex. Additionally, some Mn is needed for nitrogen solubility in the material; if nitrogen solubility is too low, as the material solidifies, nitrogen is ejected from the solid/liquid and form gas bubbles The upper limit of manganese is needed primarily for corrosion resistance. Levels above 8 or 12 wt % significantly decrease pitting corrosion resistance given the PREN equation (=% Cr+3.3(% Mo)+16(% N)−1.6(% Mn)). Likewise, excessive Mn decreases the stability of the passive layer, by increasing the defect density of the passive film making the material more prone to general corrosion.

Cu: Copper (Cu) has a strong influence on corrosion resistance in reducing acids. Cu can also aid by decreasing the solvus temperature of detrimental phases and is preferably added at a level between 0.05-5 wt %. Excessive Cu has been shown to lead to hot working problems, such as hot shortness. Therefore, a preferred Cu range is 1.75-3.5 wt %.

The lower limit of copper is need for two reasons—slight deleterious phase suppression, and corrosion resistance in reducing acids. Some Cu, like Mn, can be used to replace Ni to stabilize the austenite thus decreasing deleterious phase formation. In terms of corrosion resistance, below the level of 1.75 wt % there will not be a significate impact on corrosion resistance. The upper limit of copper is set at 3.5 wt % due to the negative impact Cu can have on hot working/hot ductility, and leading to serious tearing during mechanical deformation. Significant tearing can make a material not processable.

N: Nitrogen (N) is a very strong austenite stabilizer and also can increase alloy strength and corrosion resistance. The necessary N range to form a strong, corrosion resistant duplex alloy is 0.05-0.4 wt %. Elements such as Cr, Mn, and C impact the solubility of nitrogen in the material. Thus a N level that is too high can lead to ‘as cast’ porosity and other processing defects. Consequently, a preferred N range is 0.1-0.3 wt %.

C: Carbon (C) is an austenite stabilizer, and is necessary above 0.05 wt % to maintain proper phase balance between 40-60% ferrite and 60-40% austenite. This presence of C can also help with the solubility of nitrogen. Thus in a preferred embodiment the minimum C level is set at 0.075 wt %. Excessive carbon levels, greater than 0.35 wt % can lead to the formation of carbides, which decrease corrosion resistance. In a preferred embodiment, the maximum C level is 0.2 wt %.

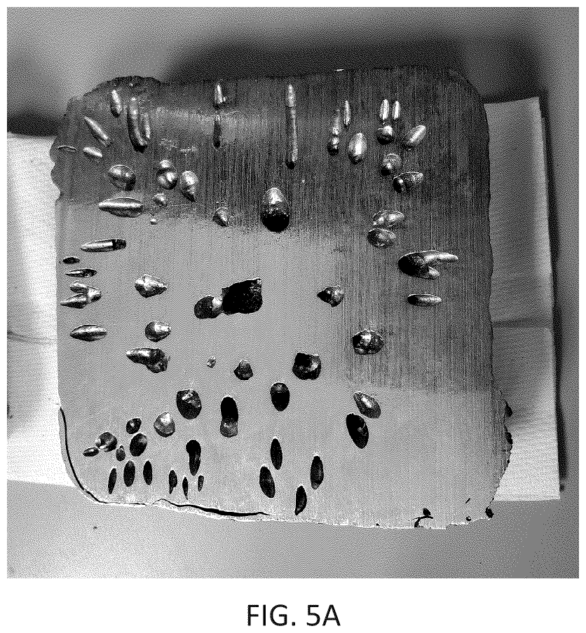

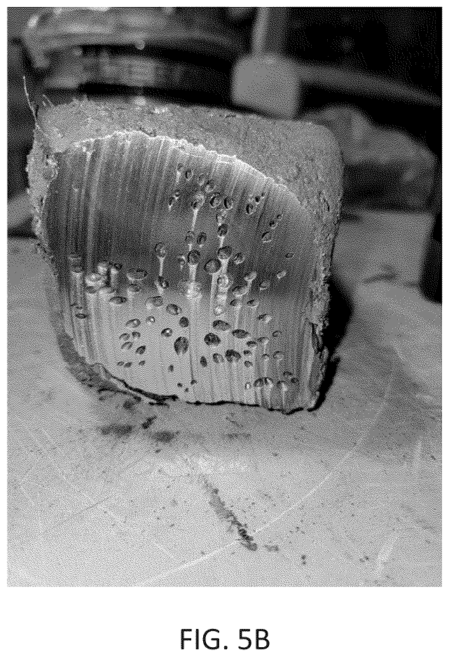

More particularly, the lower limit of carbon is needed for two reasons: nitrogen solubility and austenite stabilization (phase balance). If the carbon level is below 0.05%, the solubility of nitrogen is too low, leading to nitrogen outgassing and blow holes, as shown in FIGS. 5A and 5B. Additionally, if the carbon level is below 0.05 wt % the austenite phase fraction may be too low. One may compensate by increasing Ni, Mn, or Cu, but excessive amounts of those elements can lead to additional problems, as discussed above. At levels above 0.2 or 0.35 wt %, the carbon forms carbides with Cr and Mo, pulling these two elements out of solution and thereby decreasing the corrosion resistance of the alloy. Furthermore, increased carbon levels can lead to the material being more prone to sensitization at elevated temperatures (during part service), leading to a further decrease in Cr, a key element for corrosion resistance. As more Cr (M₂₃C₆) and Mo (M₆C) carbides form, the corrosion resistance of the alloy decreases, as well as the phase stability of ferrite.

Co: Cobalt (Co) may be used in some capacity as a Ni substitute. However, Co is not as strong an austenite stabilizer, and typically has a higher raw material cost over Ni. Thus, the Co content is less than 3.5 wt %, and preferably less than 3 wt %.

The lower limit of cobalt of 0.01 wt % is needed for one reason—austenite stabilizer (Ni substitute). Since Co is only needed to replace Ni as an austenite stabilizer, it is not needed in significant levels unless Ni is high and thus increasing the solvus temperature of deleterious phases. The upper limit of 3.5 wt % Co is set for at least partially economic reasons—the cost of Co is higher than other austenite stabilizers, so replacing Ni or Mn with a more expensive alloying element, like Co, is not necessary if there is no significate change in mechanical or corrosion properties.

Si: Silicon (Si) is generally used as an effective deoxidizing element. Si can also double as a ferrite stabilizer, but also has been shown to negatively impact material processing. Thus, the Si content is less than 2 wt % and preferably less than 1.5 wt %.

W: Tungsten (W) may be used in some capacity as a Mo substitute. When W is in the presence of Mo and Cr, it can improve corrosion resistance of stainless steels. However, high levels of W can lead to the formation of sigma and chi which are detrimental to material properties and performance. Therefore, the W content is less than 2 wt % and preferably less than 1.5 wt %.

Advantages of compositions in accordance with embodiments of the invention may include a larger temperature delta between the deleterious phase solvus and hot working temperatures than provided by other DSS compositions. The larger temperature delta increases hot workability/processability, thereby enabling easier processing of the material and lower risk of sigma/chi formation during heat treatment and quenching. In addition, these compositions provide improved mechanical properties in comparison to other DSS, providing thereby light weight and design flexibility. These improved properties can include, e.g., a yield strength (YS) of 70 ksi, ultimate tensile strength (UTS) of 115 ksi, elongation of >30%, and reduction of area (RA)>50%, as illustrated below for e.g., alloys A-H in Example 1. Finally, the compositions described herein provide corrosion resistance comparable to that of other DSS, e.g., a pitting resistance equivalent number (PREN) value of 30-45, calculated as % Cr+3.3(% Mo)+16(% N)−1.6(% Mn).

The alloys described herein may be formed by melting using conventional arc or vacuum induction melting (VIM). A suitable system may be a vacuum furnace manufactured by Consarc Corporation or ALD Vacuum Technologies. All elements of a desired composition are added to a crucible and melted together. Final and late additions (for volatile elements) can be made to achieve a final chemistry just before the material is tapped, i.e., poured. The melting step may be followed by a homogenization treatment using a standard air furnace. Once the molten metal is homogeneous, the liquid is poured into a mold, where it solidifies as it reaches room temperature.

The solidified metal may then be hardened and shaped by forging. Examples of suitable forging methods include hydraulic or mechanical press forging (using, e.g., a GFM SX-65 rotary forge, a 4500-ton press, or other similar hot working equipment) at a temperature range of 1800-2300° F. An ingot/billet may be heated up to an appropriate temperature (1800-2300° F.) followed by plastic deformation of the ingot/billet down to the required project shape and size(s).

Other methods of working this material include hot rolling, cold rolling, drawing, and extruding, e.g., with a 20-high reversing cold/hot rolling mill. Before and after this metal working step, the material may be solution annealed to relieve stress and/or dissolve an unwanted third phase. This annealing step is preferably done at the duplex temperature, i.e., the temperature at which the alloy is roughly 50% austenite, 50% ferrite. Heat treatment may take 1-4 hours, depending on product size, and followed with a water quench to room temperature.

The alloys described herein may be provided in a powder form for additive manufacturing. Accordingly, a suitable shape is spherical particulates. For laser powder based fusion (selective laser sintering (SLS) and selective laser melting, SLM), a preferred particulate size range is 15-53 microns diameter. For electron beam additive manufacturing, a preferred particulate size range is 45-103 microns. The powder may be formed by atomization. Techniques include melting charge material into a molten bath in an atmosphere including air, an inert gas, or vacuum or other similar melting practices, with the charge material including an alloy composition described herein. A molten metal stream is generated from the molten metal bath. The molten metal stream is broken into a plurality of droplets by a mixture of high-pressure gases: argon, nitrogen, helium, or other. The metal droplets cool and solidify as they fall downward into a collection chamber, to form the powder. A suitable atomization system is an atomizer, manufactured by Arcast, Retech, or ALD.

### EXAMPLES

### Example 1—High-Molybdenum Duplex Alloys

Heats were melted with compositions in accordance with embodiments of the invention as indicated in Table 3.

TABLE 3
Compositions of exemplary heats

| Alloy | Cr | Mn | Mo | Cu | Ni | N | C | Co | Fe |
|---|---|---|---|---|---|---|---|---|---|
| A | 16.06 | 4.90 | 6.94 | 3.03 | 0.76 | 0.27 | 0.078 | — | Bal. |
| B | 18.15 | 4.96 | 6.00 | 3.08 | 0.78 | 0.32 | 0.084 | — | Bal. |
| C | 14.17 | 6.78 | 8.95 | 3.09 | 0.53 | 0.30 | 0.084 | — | Bal. |
| D | 16.03 | 2.91 | 8.84 | 1.77 | 4.56 | 0.12 | 0.060 | — | Bal. |
| E | 16.07 | 2.95 | 8.90 | 1.78 | 4.56 | 0.13 | 0.058 | 0.98 | Bal. |
| F | 16.02 | 2.94 | 8.92 | 1.78 | 4.57 | 0.14 | 0.052 | 2.92 | Bal. |
| G | 15.99 | 4.88 | 8.95 | 1.78 | 3.08 | 0.13 | 0.065 | 2.95 | Bal. |
| H | 14.08 | 2.95 | 8.95 | 1.77 | 3.04 | 0.11 | 0.065 | 2.95 | Bal. |

The results of tension testing of alloys in accordance with embodiments of the invention and comparison to alloys 2205 and 2507 are indicated below in Table 4, illustrating the superior mechanical properties of high-Mo DSS, as exemplified by alloys A-H. In particular, in comparison to alloys 2205 and 2507, these alloys exhibit comparable or higher yield strength, ultimate tensile strength, percent elongation, reduction in area, and pitting resistance equivalent number.

Alloys A-H were heat treated at different temperatures corresponding to their respective duplex temperature. For example, alloy G was heat treated as follows: charge material held in a furnace at 2200° F. for 1 hour, then rapidly quenched in water. Furthermore, if an alternative heat treatment is performed to produce an alloy with ferrite content higher than the austenite content, the mechanical properties increase, i.e., improve. Conversely, if the alternative heat treatment is performed to produce an austenite content higher than the ferrite content, the mechanical properties decrease, i.e., degrade.

TABLE 4
Properties of alloys with compositions listed in Table 3

| | YS | UTS | El | RA | PREN | |
|---|---|---|---|---|---|---|
| Alloy | (ksi) | (ksi) | (%) | (%) | Min. | Reference |
| 2205 | 65 | 95 | >25 | >50 | 35 | Datasheet - UNS S31803 - Plate ASTM A240 |
| 2507 | 80 | 116 | >25 | >40 | 42 | Datasheet - UNS S32750 - |
| | | | | | | https://www.specialtymetals.com.au/product/2507- |
| | | | | | | uns-s32750-super-duplex-round-bar/ |
| A | 80 | 124 | 43 | 60 | 35.4 | R&D Heat |
| B | 78 | 125 | 45 | 60 | 35.1 | R&D Heat |
| C | 83 | 130 | 38 | 45 | 37.7 | R&D Heat |
| D | 100 | 130 | 29 | 48 | 42.5 | R&D Heat |
| E | 95 | 130 | 28 | 46 | 42.8 | R&D Heat |
| F | 90 | 130 | 31 | 45 | 43.0 | R&D Heat |
| G | 90 | 123 | 33 | 55 | 39.8 | R&D Heat |
| H | 90 | 129 | 35 | 58 | 40.7 | R&D Heat |

Corrosion testing was conducted using salt spray, and in accordance with ASTM A923-C at 25° C., and ASTM G48A at 22° C. Each of these ASTM standards are hereby incorporated by reference in their entireties. Additional details about the influence of oxygen content on the inclusion formation and pitting corrosion resistance of hyper duplex stainless steels are described in Jeon, S.-H. et al. MATERIALS TRANSACTIONS, 55(12), 1872-1877, 2014, which is hereby incorporated by reference.

The typical sigma/chi solvus temperatures, duplex temperatures, and delta temperatures of various DSS alloys are as follows:
2205—sigma/chi solvus 1775° F., duplex temperature 1950° F., delta temperature 175° F.
2507—sigma/chi solvus 1925° F., duplex temperature 2075° F., delta temperature 150° F.
2707—sigma/chi solvus 1950° F., duplex temperature 2000° F., delta temperature 50° F.
3207—sigma/chi solvus 1950° F., duplex temperature 1900° F., delta temperature 50° F.
High-Mo Duplex—1600-2100° F., depending on the Ni, Cr and Mo content ranges.

For the eight alloys discussed above, the sigma/chi solvus temperatures, duplex temperatures, and delta temperatures are:
Alloy A sigma/chi solvus 1860° F., duplex temperature 2180° F., delta temperature 300° F.
Alloy B sigma/chi solvus 1810° F., duplex temperature 2240° F., delta temperature 430° F.
Alloy C sigma/chi solvus 1945° F., duplex temperature 2000° F., delta temperature 55° F.
Alloy D sigma/chi solvus 2050° F., duplex temperature 2115° F., delta temperature 65° F.
Alloy E sigma/chi solvus 2055° F., duplex temperature 2185° F., delta temperature 130° F.
Alloy F sigma/chi solvus 2100° F., duplex temperature 2300° F., delta temperature 200° F.
Alloy G sigma/chi solvus 2080° F., duplex temperature 2200° F., delta temperature 120° F.
Alloy H sigma/chi solvus 2050° F., duplex temperature 2250° F., delta temperature 200° F.

The solvus temperatures of some materials in accordance with embodiments of the invention are comparable to that of other DSS alloys. In some embodiments, Cr and Ni can each impact the sigma solvus temperature. All of the eight alloys described above are capable of being processed and achieving superior properties, including the alloys with relatively higher sigma/chi solvus temperatures, as the delta temperature between the sigma/chi solvus temperature and the solution heat treatment is sufficiently large to produce quality material. A larger delta temperature enables the ability to produce larger diameter product forms without the precipitation of sigma/chi during cooling/quenching. Without the presence of sigma/chi phases, the degradation of mechanical and corrosion properties is decreased/eliminated as product form increases.

While the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A duplex stainless steel alloy, comprising:
from 10 wt % to 20 wt % chromium (Cr);
from 6 wt % to 13 wt % molybdenum (Mo);
from 0.5 wt % to 6.5 wt % nickel (Ni);
from 2.25 wt % to 12 wt % manganese (Mn);
from 0.05 wt % to 5 wt % copper (Cu);
from 0.05 wt % to 0.4 wt % nitrogen (N);
from 0.05 wt % to 0.35 wt % carbon (C);
from 0.01 wt % to 3.5 wt % cobalt (Co);
less than 2 wt % silicon (Si);
less than 2 wt % tungsten (W); and
iron (Fe) balance,
wherein the stainless steel alloy comprises 40 wt %-60 wt % ferrite and 60 wt %-40 wt % austenite, and has a nickel equivalent and a chromium equivalent,
wherein the nickel equivalent and the chromium equivalent are defined as one of
(i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), Ni_{eq} and Cr_{eq} having values of 7<Ni_{eq}<20 and 21<Cr_{eq}<38, respectively; or
(ii) nickel equivalent (Ni_{eq})=wt % Ni+(30×wt % C)+(0.5×wt % Mn)+(30×wt % N), and
chromium equivalent (Cr_{eq})=wt % Cr+wt % Mo+(1.5×wt % Si)+(0.5×wt % Nb), Ni_{eq} and Cr_{eq} having values of 10<Ni_{eq}<18 and 21<Cr_{eq}<27, respectively.

2. The composition of claim 1, comprising
from 12 wt % to 17 wt % chromium (Cr);
from 7.25 wt % to 11 wt % molybdenum (Mo);
from 0.75 wt % to 5 wt % nickel (Ni);
from 2.5 wt % to 8 wt % manganese (Mn);
from 1.75 wt % to 3.5 wt % copper (Cu);
from 0.1 wt % to 0.3 wt % nitrogen (N);
from 0.075 wt % to 0.2 wt % carbon (C);
from 0.01 wt % to 3 wt % cobalt (Co);
less than 1.5 wt % silicon (Si);
less than 1.5 wt % tungsten (W); and
iron (Fe) balance.

3. The duplex stainless steel alloy of claim 1, wherein the stainless steel alloy comprises cast steel.

4. The duplex stainless steel alloy of claim 1, wherein the stainless steel alloy comprises wrought steel.

5. The duplex stainless steel of claim 1, wherein the stainless steel alloy has a yield strength of at least 70 ksi.

6. The duplex stainless steel of claim 1, wherein the stainless steel alloy has an ultimate tensile strength of at least 115 ksi.

7. The duplex stainless steel of claim 1, wherein the stainless steel alloy has an elongation>30%.

8. The duplex stainless steel of claim 1, wherein the stainless steel alloy has a reduction of area>50%.

9. The duplex stainless steel of claim 1, wherein the stainless steel alloy has a pitting resistance equivalent number value of at least 30.

10. A duplex stainless steel alloy powder for additive manufacturing, comprising:
from 10 wt % to 20 wt % chromium (Cr);
from 6 wt % to 13 wt % molybdenum (Mo);
from 0.5 wt % to 6.5 wt % nickel (Ni);
from 2.25 wt % to 12 wt % manganese (Mn);
from 0.05 wt % to 5 wt % copper (Cu);
from 0.05 wt % to 0.4 wt % nitrogen (N);
from 0.05 wt % to 0.35 wt % carbon (C);
from 0.01 wt % to 3.5 wt % cobalt (Co);
less than 2 wt % silicon (Si);
less than 2 wt % tungsten (W); and
iron (Fe) balance,
wherein the stainless steel alloy comprises 40 wt %-60 wt % ferrite and 60 wt %-40 wt % austenite, and has a nickel equivalent and a chromium equivalent,
wherein the nickel equivalent and the chromium equivalent are defined as one of
(i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), Ni_{eq} and Cr_{eq} having values of 7<Ni_{eq}<20 and 21<Cr_{eq}<38, respectively; or
(ii) nickel equivalent (Ni_{eq})=wt % Ni+(30×wt % C)+(0.5×wt % Mn)+(30×wt % N), and
chromium equivalent (Cr_{eq})=wt % Cr+wt % Mo+(1.5×wt % Si)+(0.5×wt % Nb), Ni_{eq} and Cr_{eq} having values of 10<Ni_{eq}<18 and 21<Cr_{eq}<27, respectively and
wherein the powder comprises a plurality of spherical particulates having a mean particle size selected from a range of 15-53 microns or 45-103 microns.

11. The powder of claim 10, wherein the composition comprises:
from 12 wt % to 17 wt % chromium (Cr);
from 7.25 wt % to 11 wt % molybdenum (Mo);
from 0.75 wt % to 5 wt % nickel (Ni);
from 2.5 wt % to 8 wt % manganese (Mn);
from 1.75 wt % to 3.5 wt % copper (Cu);
from 0.1 wt % to 0.3 wt % nitrogen (N);
from 0.075 wt % to 0.2 wt % carbon (C);
from 0.01 wt % to 3 wt % cobalt (Co);
less than 1.5 wt % silicon (Si);
less than 1.5 wt % tungsten (W); and
iron (Fe) balance.

12. A method for forming a duplex stainless steel alloy, the method comprising the steps of:
melting a mixture of elements to form a molten metal alloy comprising
from 10 wt % to 20 wt % chromium (Cr);
from 6 wt % to 13 wt % molybdenum (Mo);
from 0.5 wt % to 6.5 wt % nickel (Ni);
from 2.25 wt % to 12 wt % manganese (Mn);
from 0.05 wt % to 5 wt % copper (Cu);
from 0.05 wt % to 0.4 wt % nitrogen (N);
from 0.05 wt % to 0.35 wt % carbon (C);
from 0.01 wt % to 3.5 wt % cobalt (Co);
less than 2 wt % silicon (Si);
less than 2 wt % tungsten (W); and
iron (Fe) balance,
wherein the stainless steel alloy comprises 40 wt %-60 wt % ferrite and 60 wt %-40 wt % austenite, and has a nickel equivalent and a chromium equivalent,
wherein the nickel equivalent and the chromium equivalent are defined as one of
(i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), Ni_{eq} and Cr_{eq} having values of 7<Ni_{eq}<20 and 21<Cr_{eq}<38, respectively; or
(ii) nickel equivalent (Ni_{eq})=wt % Ni+(30×wt % C)+(0.5×wt % Mn)+(30×wt % N), and
chromium equivalent (Cr_{eq})=wt % Cr+wt % Mo+(1.5×wt % Si)+(0.5×wt % Nb), Ni_{eq} and Cr_{eq} having values of 10<Ni_{eq}<18 and 21<Cr_{eq}<27, respectively; and
quenching the molten metal alloy to solidify the metal alloy.

13. The method of claim 12, further comprising:
forging the solidified metal alloy.

14. The method of claim 13, further comprising:
heat treating the forged metal alloy.

15. A method for forming a duplex stainless steel alloy powder comprising a composition of
from 10 wt % to 20 wt % chromium (Cr);
from 6 wt % to 13 wt % molybdenum (Mo);
from 0.5 wt % to 6.5 wt % nickel (Ni);
from 2.25 wt % to 12 wt % manganese (Mn);
from 0.05 wt % to 5 wt % copper (Cu);
from 0.05 wt % to 0.4 wt % nitrogen (N);
from 0.05 wt % to 0.35 wt % carbon (C);
from 0.01 wt % to 3.5 wt % cobalt (Co);
less than 2 wt % silicon (Si);
less than 2 wt % tungsten (W); and
iron (Fe) balance,
wherein the stainless steel alloy comprises 40 wt %-60 wt % ferrite and 60 wt %-40 wt % austenite, and has a nickel equivalent and a chromium equivalent,
wherein the nickel equivalent and the chromium equivalent are defined as one of
(i) nickel equivalent (Ni_{eq})=wt % Ni+(30×wt % C)+(0.5×wt % Mn), and chromium equivalent (Cr_{eq})=wt % Cr+wt % Mo+(1.5×wt % Si)+(0.5×wt % Nb), Ni_{eq} and Cr_{eq} having values of 7<Ni_{eq}<20 and 21<Cr_{eq}<38, respectively; or
(ii) nickel equivalent (Ni_{eq})=wt % Ni+(30×wt % C)+(0.5×wt % Mn)+(30×wt % N), and
chromium equivalent (Cr_{eq})=wt % Cr+wt % Mo+(1.5×wt % Si)+(0.5×wt % Nb), Ni_{eq} and Cr_{eq} having values of 10<Ni_{eq}<18 and 21<Cr_{eq}<27, respectively and
wherein the powder comprises a plurality of spherical particulates having a mean particle size selected from a range of 15-53 microns or 45-103 microns,
the method comprising the steps of:
melting charge material comprising the composition to form a molten metal bath;
generating a molten metal stream from the molten metal bath;
atomizing the molten metal stream to form a plurality of metal droplets; and
cooling the metal droplets, wherein the metal droplets solidify to form the powder.

16. The method of claim 15, wherein the charge material is melted in an atmosphere comprising air, an inert gas, or vacuum.

17. The method of claim 15, wherein the molten metal stream is atomized in a high-pressure gas comprising at least one of argon, nitrogen, or helium.
